(19) United States
(12) Patent Application Publication
(10) Pub. No.: US 2007/0252408 A1
(43) Pub. Date: Nov. 1, 2007

(54) Automotive Window Conversion Kit

(76) Inventor: Benjamin Tapia, Whittier, CA (US)

Correspondence Address: JOHN D. TRAN;BUUS, KIM, KUO, & TRAN, LLP, 2030 MAIN ST., SUITE 1300, IRVINE, CA, 92614, US

(21) Appl. No.: 11/740,430

(22) Filed: Apr. 26, 2007

Related U.S. Application Data
(60) Provisional application No. 60/745,662, filed on Apr. 26, 2006.

(51) Int. Cl. B60J 1/17

(52) U.S. Cl. 296/146.16

(57) ABSTRACT

An automotive window conversion kit and method thereof, comprising of packaged components, a drilling template, at least one 4″ extension rod and corresponding installation. Instructions. The kit further comprises at least one run channel in the packaging, wherein the run channel is longer than the stock run channel and at least one roller channel, wherein the roller channel has terminal ends, and each terminal end has a hole and a tab. The kit also comprising at least one front main guide capable of guiding the window glass as the window glass moves in a vertical motion, at least one outside scraper, at least one inside door panel scraper, at least one lower bump stop, a plurality of plastic plugs, and a plurality of fasteners.

### CROSS-REFERENCE TO RELATED APPLICATIONS

This non-provisional application claims priority based upon the provisional application Ser. No. 60/745,662

### FIELD OF THE INVENTION

The field of the invention is truck window installation. In particular, an apparatus and method of installing a one-piece curved tempered door glass assembly for truck bodies manufactured by General Motor during the years 1973-1991.

### BACKGROUND OF THE INVENTION

It can be appreciated that the ability to customize one's automobile can be highly desirable for car enthusiasts and hobbyists. In particular, owners of truck bodies manufactured by General Motors (“GM”) during the years 1971-1991 often desire to replace the original stock windows with a one-piece window, due to the fact that the original stock windows contained a vertical bar which was aesthetically unpleasing and detracted away from the appearance of the vehicle. Additionally, the vertical bar being located close to the middle of the door, often unnecessarily impairs the vision of the driver. Further, the lever assembly that is used to lock the vent window over-time becomes very loose which requires the owner to use various materials in attempt to lock the vent properly. However, for these types of truck bodies, there presently exists no automotive window conversion kit available that allows a non-professional or layman person the ability to easily covert the original two-piece truck window with a new one-piece truck window.

### SUMMARY OF THE INVENTION

In view of the lack of automobile window conversion kits available for GM truck bodies manufactured from 1971-1993, the general purpose of the present invention, which will be described subsequently in greater detail, is to provide an easy to install, inexpensive automotive window conversion kit which allows the ability to replace the original two-piece stock windows with a new one-piece truck window in GM truck bodies manufactured from 1971-1993. One contemplated embodiment of the current invention can be found in the article entitled “ONE-PIECE WINDOWS For '73-87 C-10's” on the March 2007 issue of Custom Classic Trucks magazine, pages 30-34, all of which is hereby incorporated by reference.

To attain this, the present invention generally comprises a packaging that includes at least one four inch long metal extension piece in the packaging. The extension piece having a first end with a first opening so the first end can be bolted to a stock rear vertical guide of an original truck door. The extension piece also having a second end with a second opening so it can be bolted to an original hole on the door where the rear vertical guide was originally fastened. Written instruction is also included within the packaging, which provides instruction on how to convert the original truck door having a vent window to have a one-piece window look. In particular, the instruction describes the removal of a vent window assembly from the original truck door and describes modification of an existing door lock assembly, wherein a consumer is instructed to shorten an original elbow piece of the door lock assembly. A paper template is also included within the packaging, wherein the template has marks indicating where new holes are to be drilled on a door structure, when the paper template is placed over the door structure. A window glass is attached to the packaging, wherein the window glass is sufficiently large to completely close a truck window after the vent window is removed.

The kit further comprises at least one run channel in the packaging, wherein the run channel is longer than the stock run channel and at least one roller channel, wherein the roller channel has terminal ends, and each terminal end has a hole and a tab. The kit also comprising at least one front main guide capable of guiding the window glass as the window glass moves in a vertical motion, at least one outside scraper, at least one inside door panel scraper, at least one lower bump stop, a plurality of plastic plugs, and a plurality of fasteners.

There has thus been outlined, rather broadly, the more important features of the invention in order that the detailed description thereof may be better understood, and in order that the present contribution to the art may be better appreciated. There are additional features of the invention that will be described hereinafter.

In this respect, before explaining at least one embodiment of the invention in detail, it is to be understood that the invention is not limited in its application to the details of the construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting. To the accomplishment of the above and related objects, this invention may be embodied in the form illustrated in the accompanying drawings, attention being called to the fact, however, that the drawings are illustrative only, and that changes may be made in the specific construction illustrated.

### BRIEF DESCRIPTION OF THE DRAWINGS

FIG. 1 is a perspective view of an original stock two-piece window;

FIG. 2 is a top down view of the present invention as seen in one packaging kit embodiment;

FIG. 3 is a view of the installation procedure which removes the original door panel;

FIG. 4 is a view of the installation procedure which removes screws from the original vent window assembly;

FIG. 5 is a view of the installation procedure which provides the user a plurality of plastic plugs to fill in the original vent window assembly screw openings;

FIG. 6 is a view of the installation procedure showing the removal of the last bolt which allows the removal of the original vent window assembly

FIG. 7 is a view of the installation procedure showing the removal of the original stock window scrapers which allows the removal of the original stock window glass;

FIG. 8 is a view of the installation procedure showing the removal of the original stock vent window assembly by lowering the original stock window all the way down before withdrawing the original stock vent assembly;

FIG. 9 is a view of the installation procedure showing the original door glass being raised all the way up to align the rollers with the notches on the stock window glass;

FIG. 10 is a view of the installation procedure with the original rollers detached from the stock window glass and depicting the removal of the original door glass;

FIG. 11 is a view of the installation procedure showing the use of a template supplied in the present invention which marks where new holes for the one-piece window conversion have to be drilled into the door;

FIG. 12 is a view of the installation procedure showing the drilling of a 1¼-inch hole into the door whereby using the included template in FIG. 11 as a guide;

FIG. 13 is a view of the installation procedure showing the elongation of the 1¼″′ inch hole as made in FIG. 12 by using a Uni-Bit which provides for window adjustment;

FIG. 14 is a view of the installation procedure showing the sizing of the door frame to ensure the new one-piece window channel material will fit correctly, by twisting a ball-peen hammer handle in the channel to open it up;

FIG. 15 is a view of the installation procedure showing the removal of the rear vertical guide from the door;

FIG. 16 is a view of the installation procedure showing the installation of a 4″ inch extension bracket which is included in the present invention kit;

FIG. 17 is a view of the installation procedure showing the result of cutting the door lock cylinder which is necessary in order to allow the one-piece window glass to avoid hitting the door lock cylinder;

FIG. 18 is a view of the installation procedure showing the user bending the door lock lever on the door lock linkage inward to ensure the one-piece window glass does not hit or contact the door lock assembly;

FIG. 19 is a view of the installation procedure showing the installation of the one-piece window by positioning the one-piece window at a 45-degree angle, lowering the one-piece window and twisting the one-piece glass window horizontally, then connecting the front and rear rollers to the one-piece window but leaving the mounting hardware loose;

FIG. 20 is a view of the installation procedure showing the user testing the final installation of the one-piece window by raising and lowering the one-piece window which checks for proper alignment;

FIG. 21 is a view of the installation procedure showing the user smoothing out a bump that is found on the original door panels which allows the one-piece products window scrapers to law flat;

FIG. 22 is a view of the installation procedure showing the final installation step which is to rivet the window scrapers in approximately four places onto the door panel and to re-attach the door panel to the door.

FIG. 23 is a view of several components of the Automotive Window Conversion Kit, including a 4″ inch extension, run channel and roller channel;

FIG. 24 is a view of several components of the Automotive Window Conversion Kit, including a lower bump stop, front main guide, rubber spacers, trip adhesive, plastic plugs, outside scrapers, nuts, bolts, washers, plugs and expansion nuts;

FIG. 25 is a view of several components of the Automotive Window Conversion Kit, including a one-piece window, felt tape, and inside door panel scraper.

### DETAILED DESCRIPTION

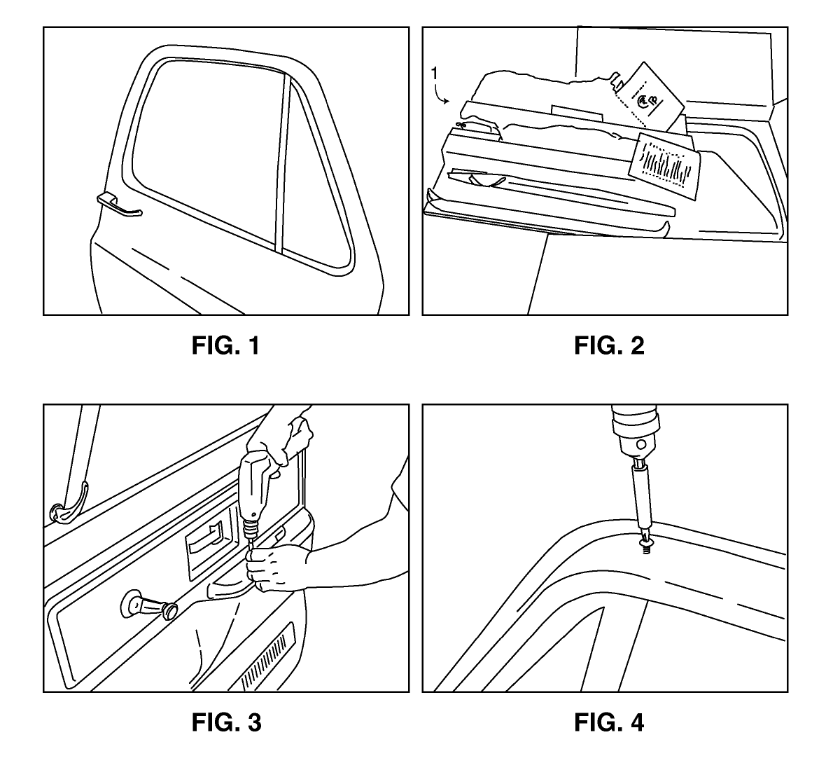

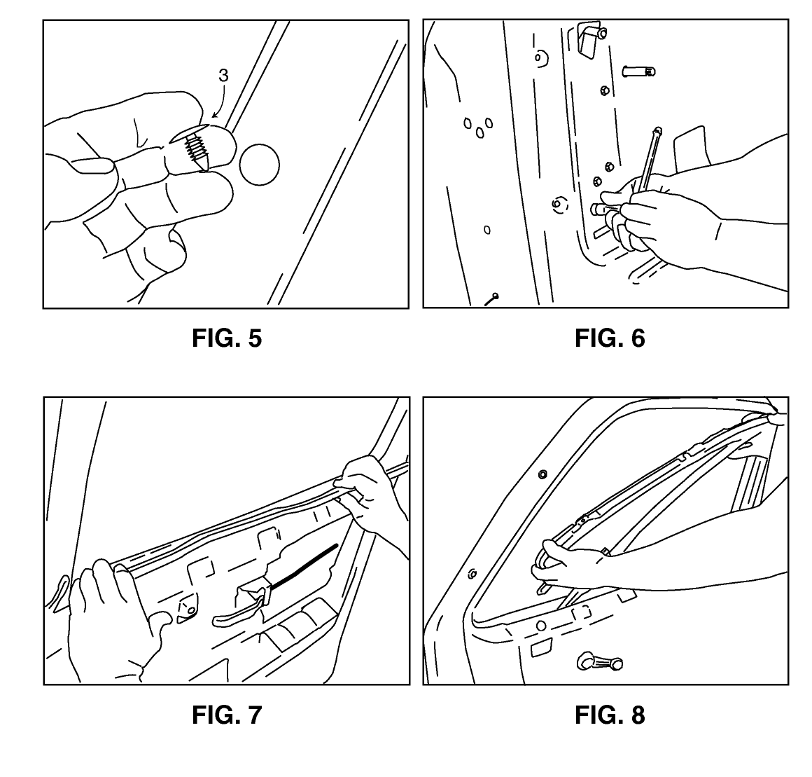

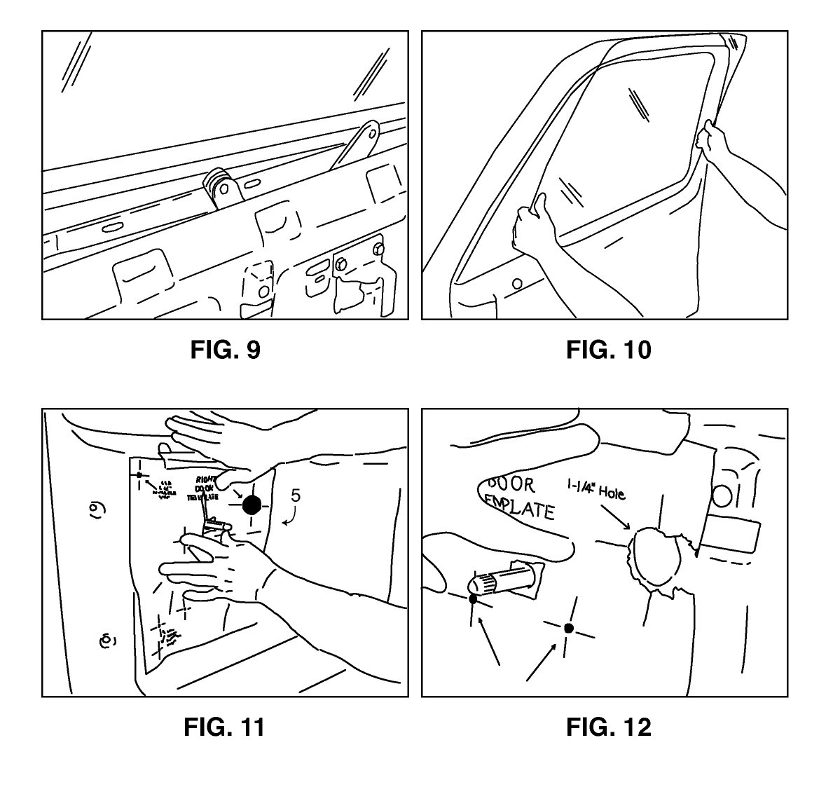

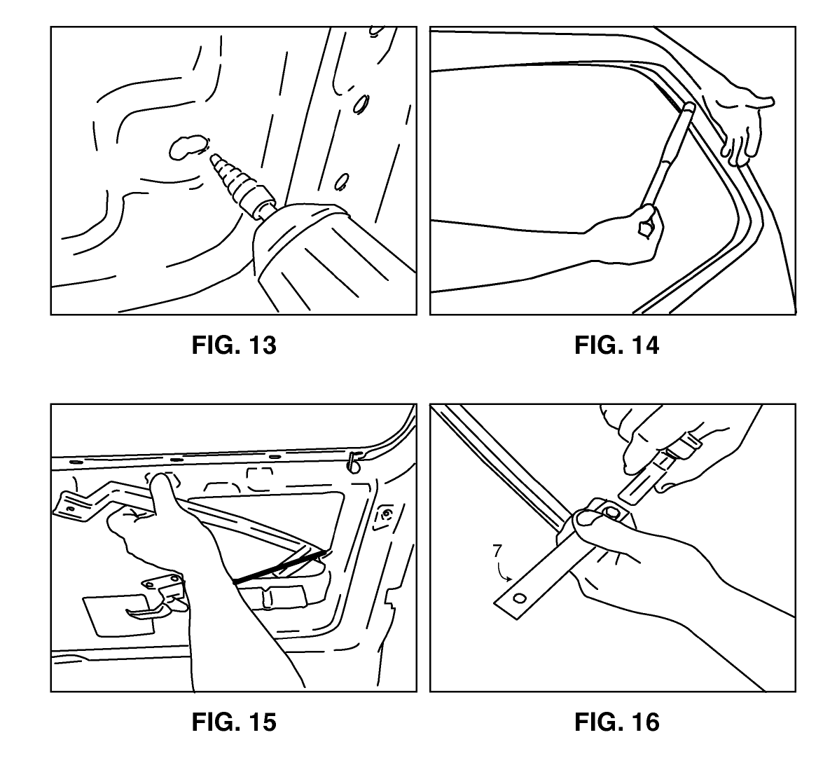

Turning now to FIG. 1, the original stock two-piece window is depicted. FIG. 2 shows the present invention kit 1 packaged in one embodiment containing all the relevant components. In one application, a typical user would first remove the original door panel as shown in FIG. 3. Next, the user would also remove the screws from the original vent window assembly as shown in FIG. 4. Following, as seen in FIG. 5, the user will install a plurality of plugs, which comes supplied in the kit 1, which will cover up the screw holes resulting from their removal from the vent window assembly. FIG. 6 shows the removal of the vent window assembly by removing the bolts that attach the vent window assembly to the door panel. In addition, in order to completely remove the vent window assembly, the door glass must be placed in its bottom position before being withdrawn as shown in FIG. 8. In preparation to remove the door window glass, the user would need to remove all the old window scrapers and felt remaining on the door as clearly seen in FIG. 7. As clearly seen in FIG. 9, before the original door glass can be removed, the original door glass needs to be raised all the way up to align the rollers with the notches on the stock window glass. Next, the user would detach the rollers from the stock window glass and remove the stock window glass from the door as seen in FIG. 10. Because of the new size and curvature of the one-piece window, modifications to the original stock lock assembly is needed in order to allow the one-piece window to properly raised and declined without contacting the original lock assembly. Therefore, as seen in FIG. 11 and 12, the user will then use a kit-supplied template 5 in order to drill 3 holes in the door, one ½″ hole, one 1⅜″ hole and one 1¼″ hole. The template is usable for both left and right door sides. With the template, the user will simply align the original 4 bolt holes of the manual regulator assembly to those on the template. FIG. 13 shows the use of a uni-bit to elongate the 1¼″ hole that was previously drilled by the template, in order to allow for window adjustability. FIG. 14 depicts the user sizing of the door frame to ensure the new one-piece window channel material 19, which is longer than the stock run channel, will fit correctly by twisting a ball-peen hammer handle in the channel to open it up. Afterwards, the user would install the pre-supplied felt assemblies 35, the inner door panel scraper 37, outside scraper 31, and the spacers 27. Standard adhesive is applied to the scrapers 35, 37, felt assemblies 35 and spacers 27 to ensure proper coupling with the door panel. In addition, the new run channel material 19 is coupled to the door frame by the standard adhesive as well. FIG. 15 shows the removal of the rear vertical guide from the door. Next, the user will bolt one end of the kit-included 4″ extension 7 to the door panel, but leaving the hole on the opposite end for the original hole on the door skin which will push the guide closer to the door latch assembly. Next the user will cut and fold the reinforcement support that crosses the lower horizontal opening and simply slide in a new front main guide 25 which is included in the present invention's kit. The new front main guide is then coupled with to the reinforcement support by the pre-supplied nuts and bolts. In addition, the user will replace the old roller channel with the pre-supplied new roller channels 21 which mounts between the door glass brackets and the rollers on the regulator. Although not pictured, the user will continue the installation process by installing the kit-included lower U-bracket 23 by replacing the original door glass bumper stop with the new lower U-bracket 23. The new lower U-bracket is necessary in order to prevent the top of the new one-piece window from traveling lower than the window frame, which is un-desired.

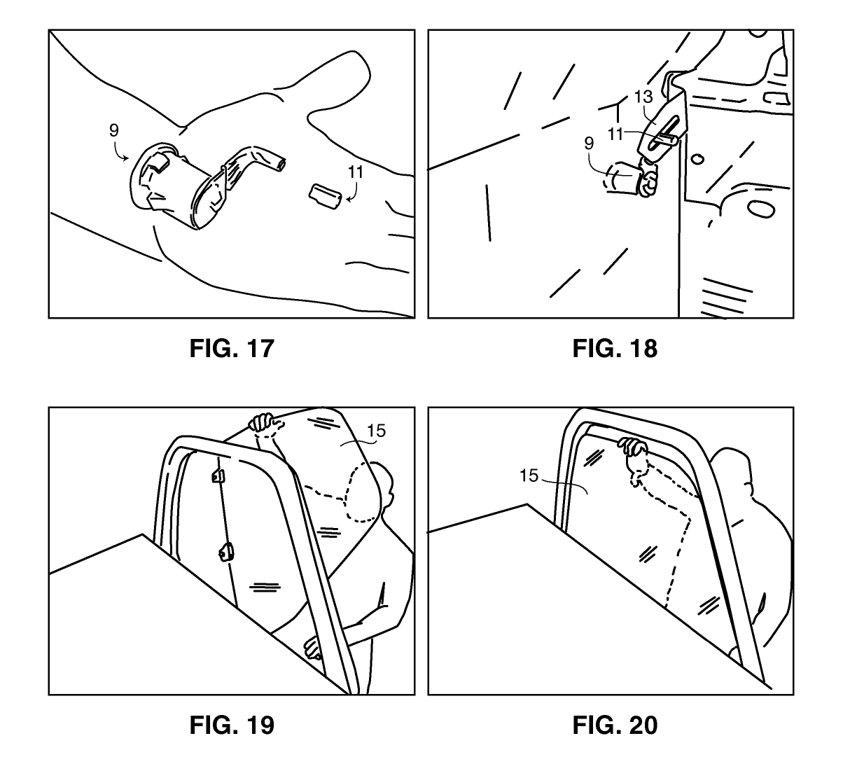

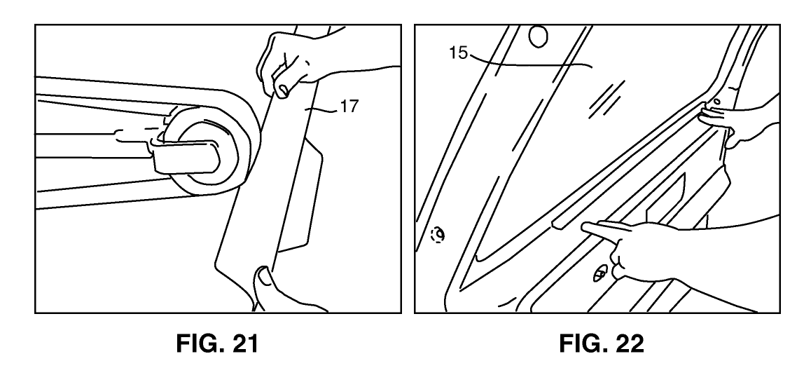

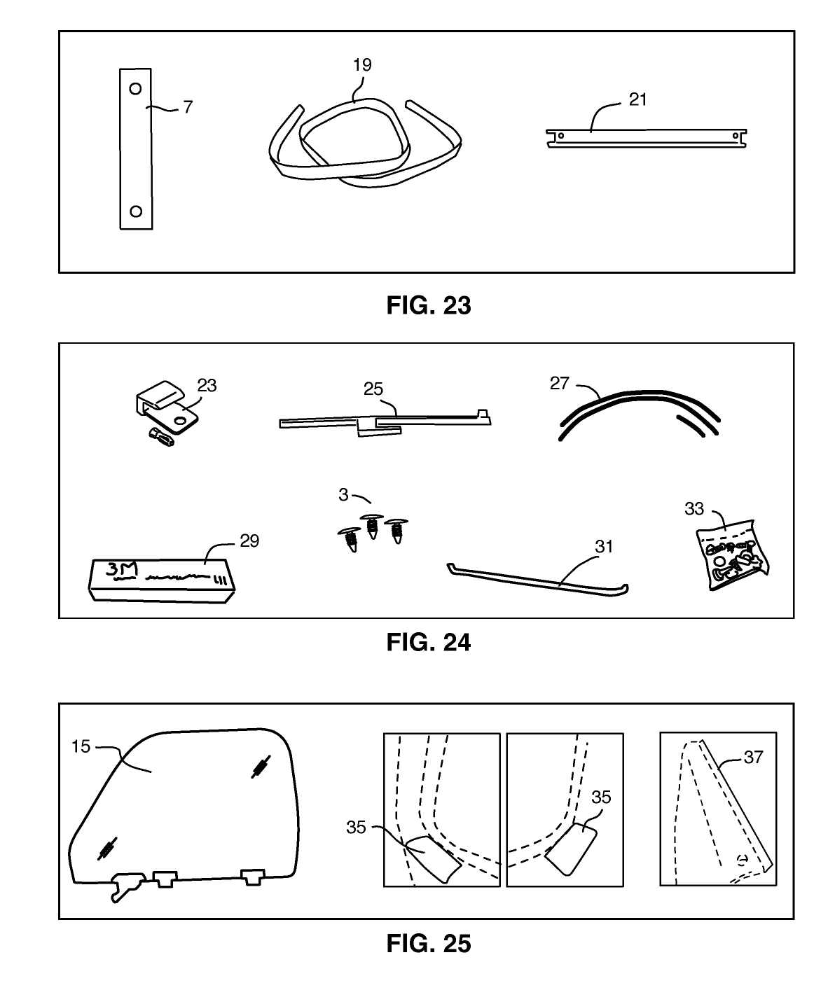

Next, it is necessary for the user to cut the tip from the door lock cylinder 11 in order to allow proper vertical motion of the new one-piece window without interference by the door lock cylinder. FIG. 17 shows the door lock cylinder 11 after it has been cut. FIG. 18 shows the user bending the door lock lever 9 on the door lock linkage 13 inward to ensure the one-piece window glass does not hit or contact the door lock assembly. FIG. 19 shows the installation of the one-piece window by positioning the one-piece window at a 45-degree angle, lowering the one-piece window and twisting the one-piece glass window horizontally, then connecting the front and rear rollers to the one-piece window but leaving the mounting hardware loose. Lastly, FIG. 20 depicts the user testing the final installation of the one-piece window by raising and lowering the one-piece window which checks for proper alignment. If need be, FIG. 21, shows the user may grind down the original door panel to remove any unwanted bumps that may not allow the new scrapers 31 and 37 to lay completely flat. Both scrapers, 31 and 37, are used to prevent unwanted rattling of the glass. FIG. 22 shows the final installation step which is to rivet the window scrapers in approximately four places onto the door panel and to re-attach the door panel to the door.

Thus, specific embodiments and applications of the Automotive Window Conversion Kit have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

What is claimed is:

1. An automotive window conversion kit for any one of year model 1973 to 1991 General Motors or Chevrolet C-10 trucks, the kit comprising:
a packaging;
at least one four inch long metal extension piece in the packaging, wherein the extension piece has a first end and a second end, wherein the first end has a first opening so the first end can be bolted to a stock rear vertical guide of an original truck door, wherein the second end has a second opening so it can be bolted to an original hole on the door where the rear vertical guide was originally fastened;
a written instruction within the packaging, wherein the written instruction provides instruction on how to convert the original truck door having a vent window to have a one-piece window look;
wherein the instruction describes removal of a vent window assembly from the original truck door;
wherein the instruction describes modification of an existing door lock assembly, wherein a consumer is instructed to shorten an original elbow piece of the door lock assembly;
a paper template within the packaging, wherein the template has marks indicating where new holes is to be drilled on a door structure, when the paper template is placed over the door structure; and
a window glass attached to the packaging, wherein the window glass is sufficiently large to completely close a truck window after the vent window is removed.

2. The kit as recited in claim 1 further comprising at least one run channel in the packaging, wherein the run channel is longer than the stock run channel.

3. The kit as recited in claim 2 further comprising at least one roller channel, wherein the roller channel has terminal ends, and each terminal end has a hole and a tab.

4. The kit as recited in claim 3 further comprising at least one front main guide capable of guiding the window glass as the window glass moves in a vertical motion.

5. The kit as recited in claim 4, wherein the packaging further includes at least one outside scraper, at least one inside door panel scraper, at least one lower bump stop, a plurality of plastic plugs, and a plurality of fasteners.

6. An automotive one-piece window conversion kit for an automobile, the kit comprising:
a front main guide having a front guide groove capable of guiding a vertical movement of a window glass, and the main guide has a plurality of attachment points that fasten to the door frame; and
an instruction describing that the kit is capable of converting a stock automotive window from having a vent window to an automotive window having a one-piece window.

7. The kit as recited in claim 6, wherein the instruction provides at least one location to drill a hole on the door frame to accommodate attachment of the front main guide, wherein the instruction is selected from at least one of:
a. a written instruction,
b. a graphical illustration,
c. a printed template,
d. an audio-visual illustration recorded on an electronic media, and
e. an internet address where at least one of a, b, c and d is available.

8. The kit as recited in claim 7 further comprising a roller channel having attachment points capable of being fastened to brackets of a one-piece window glass, and the roller channel has a longitudinal channel to receive at least one roller from a glass-lifting arm in a door.

9. The kit as recited in claim 8 further comprising an extension piece having a first end and a second end, wherein the first end has a first attachment structure that is capable of being fastened to a stock rear vertical guide, and the second end has a second attachment structure that is capable of being fastened to a hole on the door frame where the stock rear vertical guide was originally fastened by an original manufacturer, such that the extension piece displaces the stock rear vertical guide;

10. The kit as recited in claim 9, wherein the extension piece displaces an end of the stock rear vertical guide towards a rear end of the automobile.

11. The kit as recited in claim 10, wherein the extension piece displaces the end of the stock rear vertical guide towards the rear end of the automobile by about 2 to 6 inches;

12. The kit as recited in claim 11 further comprising a packaging that encloses the extension piece, the roller channel, and the front main guide.

13. The kit as recited in claim 8 further comprising a modified rear vertical guide to replace a stock rear vertical guide having a stock guiding groove, the modified rear vertical guide has a modified guiding groove such that when installed in the door, the modified guiding groove is at a position in the door frame relatively different than an original position of the stock guiding groove.

14. The kit as recited in claim 7, wherein the instruction instructs a consumer to remove a distal portion of an extending arm of a door lock cylinder, thereby shortening the extending arm.

15. The kit as recited in claim 14, wherein the instruction provides that the extending arm should be shortened by about half an inch.

16. The kit as recited in claim 15, wherein the instruction instructs a consumer to bend a lever on a door lock linkage towards the extending arm so as to accommodate the shortened extending arm, such that the shortened extending arm can operatively make engaging contact with the lever.

17. The kit as recited in claim 16, wherein the automobile is a General Motors or Chevrolet truck with any one of year model 1973 to 1991.

18. The kit as recited in claim 17, wherein the truck is a C-10.

19. The kit as recited in claim 7, wherein the instruction instructs a consumer to create an opening on the door frame at a position closer to a rear end of the automobile than the at least one location is, wherein the opening allows consumer access to a bottom portion of a one-piece window glass to adjust a guide bracket that is attached to the glass, when the guide bracket is coupled to the guide groove.

20. The kit as recited in claim 19 further comprising the one-piece window glass sufficiently large to cover the stock automotive window after the vent window is permanently removed, and wherein the glass has at least one other bracket attached to the bottom portion of the glass.

21. The kit as recited in claim 7 further comprising a run channel longer than a stock run channel so as to sufficiently cover a top side, a front side, and a rear side of the window frame of the one-piece window.

22. The kit as recited in claim 7 further comprising an outside scraper, an inside scraper, and wherein the instruction instructs the consumer to replace two original door hinge bolts with two shorter bolts.

23. A method of marketing automotive conversion parts, the method comprising:
provide an instruction on how to convert a truck window so as to eliminate an original vent window, and to create a look of a one-piece window;
provide conversion parts to effectuate the conversion;
provide a packaging that includes the instruction and the conversion parts;
wherein the instruction is selected from at least one of:
a. a written instruction,
b. a graphical illustration,
c. a printed template
d. an audio-visual illustration recorded on an electronic media, and
e. an internet address where at least one of a, b, c, and d is available.

24. The method as recited in claim 23, wherein the instruction further instructs a consumer to:
f. drill a hole on at least one specific location of a door frame; and
g. install a front main guide in the door.

25. The method as recited in claim 24, wherein the conversion parts include the front main guide having a guide groove capable of guiding a vertical movement of a one-piece window glass, and the main guide has attachment points that fasten to the door frame.

26. The method as recited in claim 25, wherein the instruction further includes creating an opening on the door frame, wherein the opening allows consumer access to a bottom portion of the one-piece window glass to adjust a guide bracket attached to the glass, when the guide bracket is coupled to the guide groove.

27. The method as recited in claim 26, wherein the method further comprises offering for sale the one-piece window glass, either separately or together with the packaging.

28. The method as recited in claim 27, wherein the glass is sufficiently large to cover the entire automotive window after the vent window is permanently removed, wherein the glass has at least one other bracket attached to the bottom portion of the glass.

29. The method as recited in claim 28, wherein the conversion parts include an extension piece having a first end and a second end, wherein the first end is capable of being fastened to a stock rear vertical guide, and the second end is capable of being fastened to a position on a door frame where the stock rear vertical guide was originally fastened as originally manufactured, such that the extension piece displaces the stock rear vertical guide in the door.

30. The method as recited in claim 29, wherein the extension piece displaces an end of the stock rear vertical guide towards a rear end of the truck by about 2 to 6 inches.

31. The method as recited in claim 30, wherein the conversion parts include a new roller channel having a plurality of attachment structures to fasten to the glass, and the roller channel has a longitudinal channel capable of receiving at least one roller from a stock glass-lifting arm in the door.

32. The method as recited in claim 28, wherein the truck is a General Motors or Chevrolet truck.

33. The method as recited in claim 32, wherein the truck is one of year model 1973 to year model 1991.

34. The method as recited in claim 32, wherein the truck is a C-10.

35. The method as recited in claim 28, wherein the conversion parts include a new rear guide to replace a stock rear guide, the new rear guide has a guiding groove, when installed on the door frame, wherein the guiding groove has one end located closer to a rear end of the truck than an end of a guiding groove of the stock rear guide as originally installed.

36. The method as recited in claim 28, wherein the instruction includes:
h. remove a distal portion of an extending arm of a door lock cylinder, thereby shorten the extending arm by about half an inch; and
i. bend a lever on a door lock linage towards the extending arm so as to accommodate the shortened extending arm, such that the shortened extending arm is capable of making engaging contact with the lever.

37. The method as recited in claim 28, wherein the conversion parts include a run channel longer than a stock run channel so as to sufficiently cover a top side, a front side, and a rear side of a window frame of the one-piece window.

38. The method as recited in claim 28, wherein the conversion parts further comprises an outside scraper, an inside scraper, and wherein the instruction further instructs the consumer to replace at least one stock door hinge bolts.
